(19) United States
(12) Patent Application Publication
(10) Pub. No.: US 2006/0144251 A1
(43) Pub. Date: Jul. 6, 2006

(54) Cooking implement using molded salt

(75) Inventors: Kang Lee, Gyeonggi-Do (KR); Gui Hyun Kwak, Incheon-Si (KR)

Correspondence Address: MERCHANT & GOULD PC, P.O. BOX 2903, MINNEAPOLIS, MN, 55402-0903, US

(73) Assignee: Kang Lee, Gyeonggi-Do (KR)

(21) Appl. No.: 11/326,241

(22) Filed: Jan. 5, 2006

(30) Foreign Application Priority Data
Jan. 5, 2005 (KR) 2005-847

(51) Int. Cl. A47J 37/10

(52) U.S. Cl. 99/422

(57) ABSTRACT

Disclosed herein is a cooking implement using molded salt. The cooking implement of the present invention is manufactured by molding salt in a desired shape, thus preventing meat while cooking from being burned thanks to the lower thermal conductivity of salt, and having high far infrared radiation efficiency and superior impurity absorbing ability.

### BACKGROUND OF THE INVENTION

1. Field of the Invention

The present invention relates generally to cooking implements for cooking meat and, more particularly, to a cooking implement using molded salt which is manufactured by molding salt in a desired shape, thus preventing meat while cooking from being burned thanks to the lower thermal conductivity of salt, and having high far infrared radiation efficiency and superior impurity absorbing ability.

2. Description of the Related Art

Generally, when roasting or frying raw food such as meat, seafood, or shellfish having a relatively hard fleshy texture, using a fire is a representative cooking method for intake of food. When cooking meat using fire, a characteristic smell and taste are provided for a user. In particular, when cooking beef or pork, the cooking method using fire is mainly used.

There are several methods of cooking food, in particular, meat, using a fire. Furthermore, various related cooking utensils have been developed. As representative examples, there is a roasting method in which meat is placed on a cooking implement such as a grill, having a net-like structure, so that the surface of the meat is directly exposed to a fire. Furthermore, there is a frying method in which meat is placed on a metal plate, such as a frying pan or a griddle, having high thermal conductivity, so that the meat is indirectly exposed by a fire.

However, in the case of the roasting method in which meat directly contacts a fire, there has been a problem in that, when the fat of meat contacts the fire and is burned, a carcinogenic substance is generated and adhered to the surface of the meat, thus injuring a user's health.

Furthermore, in the case of the frying method, in which meat indirectly contacts a fire, because the frying pan and the griddle are mainly made of cast iron having high thermal conductivities, it is hard to evenly cook meat. In other words, the inside of the meat may be underdone despite the surface of the meat being burned. Particularly, the burned meat is distasteful and, as well, contains a carcinogenic substance, so that it may be harmful to humans. Furthermore, in the above-mentioned cooking method using a frying implement such as a frying pan or a griddle, not only the meat itself may be burned, but also oil flowing from the meat may be burned, causing harm to humans. Such frying implements were proposed in Korean Utility Model Registration No. 0288003 and No. 0269970. These frying implements are formed as simple metal plates having structures such that meat is cooked merely using conductive heat. However, in the case of the conventional frying implement made of the metal plate, such as a steel plate having high thermal conductivity, meat is scorched and adhered to the surface of the frying implement in an initial stage, and the adhered portion of the meat is easily burned. Furthermore, in the case of cooking spiced meat using the conventional frying implement, there is a problem in that the spice may be also adhered to the frying implement and be burned.

Meanwhile, according to development of technology, various microwave ovens and the like have been proposed and used. However, such a microwave oven is expensive and does not use a roasting or frying method. Furthermore, it is impossible to eat some meat while roasting or frying it. As such, the microwave oven is not well adapted to cooking meat.

### SUMMARY OF THE INVENTION

Accordingly, the present invention has been made keeping in mind the above problems occurring in the prior art, and an object of the present invention is to provide a cooking implement using molded salt which is manufactured by molding salt in a desired shape, thus preventing meat while cooking from being burned thanks to the lower thermal conductivity of salt, and having high far infrared radiation efficiency and superior impurity absorbing ability.

In an aspect, the present invention provides a cooking implement using molded salt, including a salt griddle formed as a plate shape using molded salt.

The salt griddle may have a groove thereon.

The cooking implement may further include a sidewall part provided along an outside edge of the salt griddle.

The cooking implement may further include an internal reinforcing member provided in the salt griddle.

The internal reinforcing member may comprise a metal net formed by crossing a plurality of metal cores or metal wires.

The cooking implement may further include an external protective frame, into which the salt griddle is seated.

The cooking implement may further include a cover covering the salt griddle.

The cover may include a salt layer and a cover protective layer.

In another aspect, a cooking implement using molded salt, including: a pair of casings roatably coupled to each other by a hinge; a pair of salt blocks charged in the respective casings, with a cooking cavity defined at a predetermined position in the salt blocks; and a hook and a catch provided on the respective casings so that the hook is locked to or unlocked from the catch to close or open the casings.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a cooking implement using molded salt, according to a first embodiment of the present invention;

FIG. 2 is a perspective view of a cooking implement using molded salt, according to a second embodiment of the present invention;

FIG. 3 is a sectional view taken along line A-A of FIG. 2;

FIG. 4 is a perspective view of a cooking implement using molded salt, according to a third embodiment of the present invention;

FIG. 5 is a sectional view of a cooking implement using molded salt, according to a fourth embodiment of the present invention;

FIG. 6 is a sectional view of a cooking implement using molded salt, according to a fifth embodiment of the present invention; and

FIG. 7 is a perspective view of a cooking implement using molded salt, according to a sixth embodiment of the present invention.

### DESCRIPTION OF THE PREFERRED EMBODIMENTS

Hereinafter, cooking implements using molded salt according to preferred embodiments of the present invention will be described in detail with reference to the attached drawings.

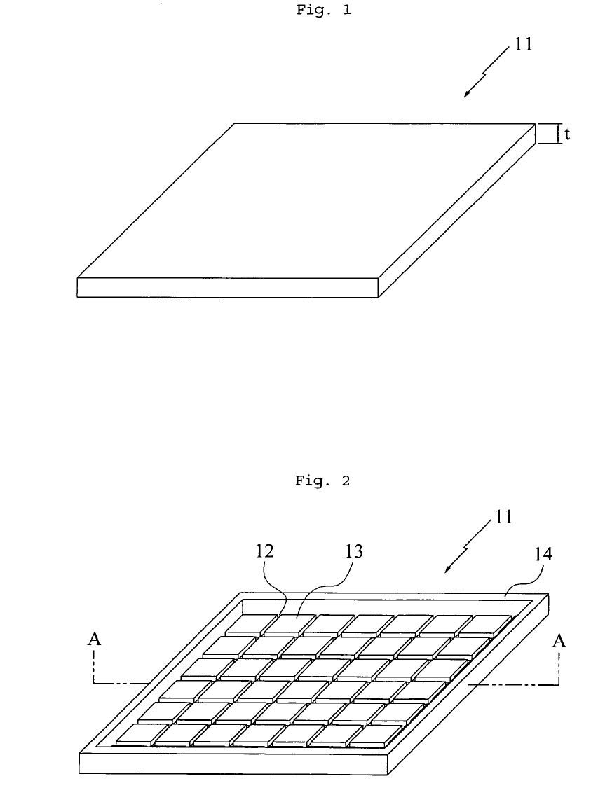

As shown in FIG. 1, the cooking implement using molded salt according to a first embodiment of the present invention has a plate shape. Described in detail, the cooking implement of this first embodiment comprises a salt griddle 11 which is formed by putting natural salt or refined salt into a mold and compressing it at a high pressure of approximately 300 tons using a typical press. Those skilled in the art will easily appreciate that the formation of the salt griddle 11 of the cooking implement is realized by compressing salt at high pressure using the typical press. Furthermore, those skilled in the art will easily appreciate that pressure required to form the salt griddle 11 may be varied depending on thickness and strength of the salt griddle 11.

Furthermore, the salt griddle 11 of the cooking implement of the present invention may be formed through a process in which salt is partially melted in a mold by heating it at a temperature of 300° C. and compressing it using a typical press at a pressure of 300 tons. Here, conditions of forming the salt griddle 11 are not limited to the above-mentioned pressure and temperature, and the above-mentioned conditions must be appreciated merely as an example of pressure and temperature conditions suitable for forming the salt griddle 11 according to the intended purpose.

Furthermore, the salt griddle 11 of the cooking implement of the present invention may be formed by heat-evaporating a saturated salt solution charged in a mold.

As such, the salt griddle 11 of the cooking implement of the present invention may be formed by the above-mentioned methods. However, the present invention is not limited to these.

Meanwhile, the cooking implement using molded salt of the present invention may be made of only salt or, alternatively, an edible binder may be used. The edible binder makes it easier to form the cooking implement. Here, dibasic calcium phosphate that is harmless to human may be used as the binder, but the present invention is not limited to this. Preferably, the binder is contained within a range from 1% to 3% of the entire weight of salt which is used in forming the cooking implement using molded salt.

It is preferable that the salt griddle 11 of the cooking implement have a thickness ranging from 10 mm to 30 mm.

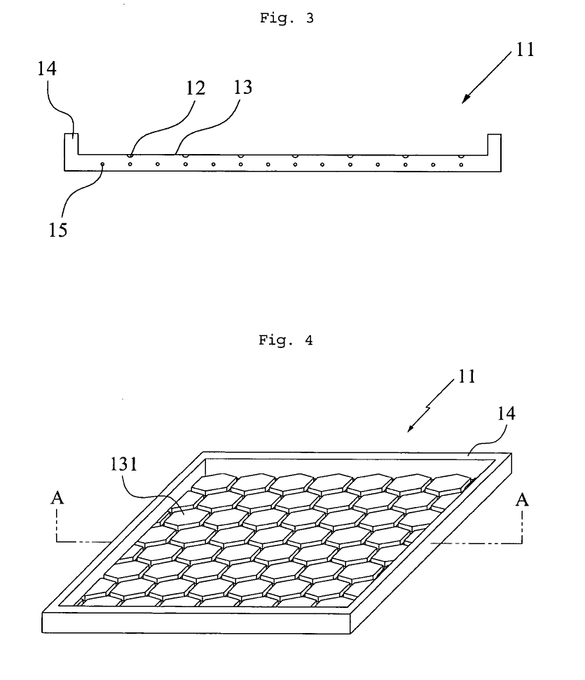

According to the first embodiment of the present invention, the cooking implement using molded salt may be formed as a simple flat griddle as shown in FIG. 1. Unlike the first embodiment, the cooking implement using molded salt according to a second embodiment may be formed as a grooved griddle having a plurality of grooves 12 thereon, as shown in FIG. 2. In this case, a plurality of plateaus 13 is defined on the salt griddle 11 by forming the grooves 12. As shown in FIG. 2, if the grooves 12 are linearly formed such that they cross each other, the plateaus 13 are defined in rectangular shapes. Alternatively, as shown in FIG. 4, illustrating the cooking implement using molded salt according to a third embodiment, a plurality of plateaus 131 may be defined on the salt griddle 11 in hexagonal shapes. Not shown in the drawings, the grooves 12 may be formed in the salt griddle 11 such that the plateaus of the salt griddle 11 of the cooking implement are defined in various other shapes, such as circular shapes or rhombic shapes. The grooves 12 serve to easily discharge oil flowing out from meat when cooking the meat.

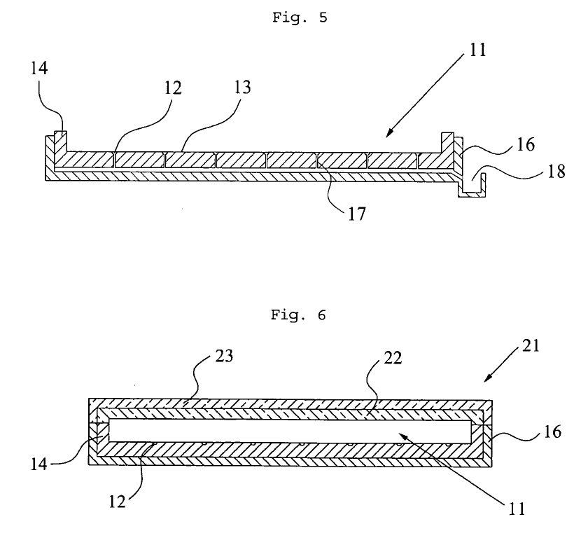

Meanwhile, as shown in FIG. 5, illustrating the cooking implement using molded salt according to a fourth embodiment, the cooking implement using molded salt of the present invention may have a plurality of oil discharge holes 17. The oil discharge holes 17 are formed through the salt griddle 11 of the cooking implement. The oil discharge holes 17 have functions such that oil flowing out from meat is discharged to the outside of the cooking implement more rapidly. Preferably, each of the oil discharge holes 17 has a cylindrical shape with a diameter ranging from approximately 1 mm to approximately 2 mm. Particularly, in the fourth embodiment of FIG. 5, the oil discharge holes 17 are formed in the grooves 12 of the salt griddle 11. Furthermore, the cooking implement using molded salt according to the fourth embodiment has an external protective frame 16. Therefore, meat oil, which is in the grooves 12, flows downwards through the oil discharge holes 17 of the salt griddle 11, thus reaching the bottom of the external protective frame 16, and is discharged to the outside of the cooking implement. Here, the outside reinforcement frame 16 serves as both a thermal conductive plate and a reinforcing plate. Furthermore, the outside reinforcement frame 16 has a function of discharging oil from meat to the outside. Meanwhile, an oil collector 18, which collects oil discharged outside the external protective frame 16, is preferably provided along a lower edge of a sidewall of the external protective frame 16.

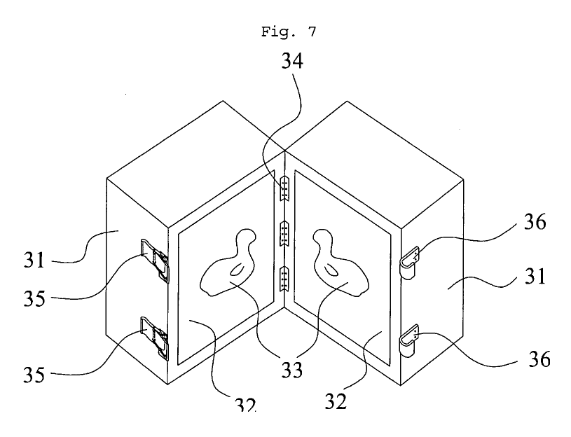

Furthermore, as shown in FIG. 2, illustrating the second embodiment, the salt griddle 11 of the cooking implement of the present invention may further include a sidewall part 14 which has a predetermined height and is formed along the outside edge of the salt griddle 11. The sidewall part 14 serves to reinforce the salt griddle 11 such that the salt griddle 11 is not easily broken even if the salt griddle 11 is relatively thin. In addition, the sidewall part 14 serves to increase thermal conductivity of the salt griddle 11 to an appropriate level such that meat is appropriately fried. As well, in the case that a cover 21 (see, FIG. 6) is used, the sidewall part 14 serves to support the cover 21.

As shown in FIG. 6, illustrating the cooking implement according to a fifth embodiment, the cover 21 may include a salt layer 22 and a cover protective layer 23 which is fitted over the salt layer 22. Alternatively, the cover 21 may include only the salt layer 22. The cover 21 prevents heat from radiating while frying meat, thereby cooking of the meat is executed more rapidly.

Meanwhile, the cooking implement using molded salt of the present invention may further include an internal reinforcing member 15, which is provided in the salt griddle 11 to prevent the salt griddle 11 from being easily broken due to a reduced thickness, as shown in FIG. 3, which is a sectional view of the second embodiment. The salt griddle 11, having the internal reinforcing member 15 therein, is manufactured by molding salt in a state in which the internal reinforcing member 15 was previously placed in the salt. The internal reinforcing member 15 may comprise a plurality of steel wires. Alternatively, the internal reinforcing member 15 may comprise a metal net which is formed by crossing metal wires, such as steel wires, in a net shape. However, the present invention is not limited to these.

Meanwhile, in the cooking implement using molded salt according to the fifth embodiment, an external protective frame 16 is provided on the outer surface of the salt griddle 11. The external protective frame 16 may be made of a metal plate. The external protective frame 16 serves to reinforce the salt griddle 11, thus preventing the salt griddle 11 from being broken.

The salt griddle 11 for frying meat according to the present invention has an advantage in that meat is not easily burned thanks to the low thermal conductivity of salt. Furthermore, the inside of the meat is evenly cooked by far infrared rays generated from the salt griddle when heated. That is, the salt griddle 11 of the present invention prevents the inside of the meat from being underdone despite the surface of the meat being burned, such that the meat is evenly cooked. In addition, because salt has deliquescence and the ability to absorb impurities, in particular, heavy metals, cooking and eating food, such as meat, using the present invention is beneficial to health.

Meanwhile, FIG. 7 shows the cooking implement according to a sixth embodiment of the present invention. As shown in FIG. 7, the cooking implement using molded salt according to the sixth embodiment comprises a salt block. Therefore, this embodiment is applied to cooking poultry, such as a chicken or a duck, or a bulk of meat, in particular, ribs. The cooking implement according to this embodiment includes a pair of casings 31, which are roatably coupled to each other by a hinge 34 so that the casings 31 are opened or closed, and a salt block 32, which is charged in each casing 31. A cooking cavity 33 is defined at a predetermined position in the salt blocks 32. Hooks 35 and catches 36 are provided on respective sidewalls of the casings 31 which are sidewalls opposite from which the hinge 34 is provided. Thus, when the hooks 35 and catches 36 are locked to each other, the casings 31 are closed. When the hooks 35 and catches 36 are unlocked from each other, the casings 31 are opened.

To use the cooking implement according to the sixth embodiment of the present invention, the user unlocks the hooks 35 from the catches 36 to open the casings 31. Thereafter, the user puts a bulk of meat to be cooked into the cooking cavity 33 and closes the casings 31 in a process opposite to the process for opening the casings 31. Subsequently, the cooking implement is applied to a heat source to cook the meat placed in the cooking cavity 33. Formation of each salt block 32 is realized by heating and compressing it in the same manner as that of the salt griddle 11. In the case of the salt block 32, a pressure condition for forming the salt block 32 may be varied depending on the thickness and strength of the salt block 32. It is preferable that the salt block 32 be formed by compressing it at a pressure ranging from 500 tons to 1,500 tons. Of course, those skilled in the art will appreciate that the pressure applied to formation of the salt block 32 may be appropriately varied according to whether a binder is used or according to the strength of the casings 31.

Although cooking meat has been explained as an example, it will be, of course, appreciated that the present invention may be used to cooking any raw foods, such as seafood and shellfish that have relatively hard fleshy texture.

As described above, the present invention provides a cooking implement for cooking meat which is manufactured by molding salt in a desired shape, thus preventing meat while cooking from being burned thanks to lower thermal conductivity of salt, and having high far infrared radiation efficiency and superior impurity absorbing ability. Furthermore, because meat while cooking is not scorched on the cooking implement, the present invention makes it easier to wash the cooking implement after using it.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A cooking implement using molded salt, comprising:
a salt griddle formed as a plate shape using molded salt.

2. The cooking implement as set forth in claim 1, wherein the salt griddle has a groove thereon.

3. The cooking implement as set forth in claim 1, further comprising:
a sidewall part provided along an outside edge of the salt griddle.

4. The cooking implement as set forth in claim 1, further comprising:
an internal reinforcing member provided in the salt griddle.

5. The cooking implement as set forth in claim 4, wherein the internal reinforcing member comprises a metal net formed by crossing a plurality of metal cores or metal wires.

6. The cooking implement as set forth in claim 1, further comprising:
an external protective frame, into which the salt griddle is seated.

7. The cooking implement as set forth in claim 3, further comprising:
a cover covering the salt griddle.

8. The cooking implement as set forth in claim 7, wherein the cover comprises a salt layer and a cover protective layer.

9. A cooking implement using molded salt, comprising:
a pair of casings roatably coupled to each other by a hinge;
a pair of salt blocks charged in the respective casings, with a cooking cavity defined at a predetermined position in the salt blocks; and
a hook and a catch provided on the respective casings so that the hook is locked to or unlocked from the catch to close or open the casings.
